(19) United States
(12) Patent Application Publication
(10) Pub. No.: US 2013/0331116 A1
(43) Pub. Date: Dec. 12, 2013

(54) TRANSMITTING INITIATION DETAILS FROM A MOBILE DEVICE

(71) Applicants: Thomas Kuehnel, Seattle, WA (US); Amer Hassan, Kirkland, WA (US)

(72) Inventors: Thomas Kuehnel, Seattle, WA (US); Amer Hassan, Kirkland, WA (US)

(73) Assignee: Microsoft Corporation, Redmond, WA (US)

(21) Appl. No.: 13/489,483

(22) Filed: Jun. 6, 2012

(51) Int. Cl. H04W 4/02

(52) U.S. Cl. 455/456.1

(57) ABSTRACT

Act initiation details can be automatically selected based on time information in a time-based object in a mobile device. In response to a gesture made with the mobile device and sensing a proximity of the mobile device to a receiving device, the selected act initiation details can be transmitted to the receiving device. The act initiation details may be call initiation details that can be received from the mobile device at the receiving device. The receiving device can use the call initiation details to place a telephone call represented by the call initiation details without using the mobile device as a telephone for the call.

### BACKGROUND

Entering details to initiate an act on a shared device can be cumbersome. Such details are often stored on a user's mobile device. Accordingly, a user may open an object on the mobile device (e.g., a calendar entry or a contact) to view the initiation details, and then manually enter the details in the shared device. As just one example, setting up a unified communications (UC) telephone call (participant-interactive video-only, video and voice, or voice-only communications) from a conference room can involve a user manually entering in the UC telephone the phone number of the conference bridge or remote subscriber, and possibly also credentials and codes that authorize the conference room to participate in the call. Entering such information can be particularly cumbersome in conference rooms where a speaker UC telephone is at the center of a large conference room table.

### SUMMARY

The tools and techniques described herein relate to transmitting act initiation details from a mobile device to a receiving device, such as a shared receiving device. Such details can be used by the receiving device to initiate one or more acts related to the details. This may be done without the user manually entering the initiation details in the receiving device.

In one embodiment, the tools and techniques can include sensing a physical proximity of a mobile device to a receiving device (e.g., sensing that the devices are within range for a near field communications signal, sensing that the mobile device has been electrically connected to the receiving device at a connector near the receiving device, such as by being placed in a docking station near (e.g., in the same room as) the receiving device, etc.). The technique can also include the receiving device receiving call initiation details from the mobile device. The receiving device can use the call initiation details to place a telephone call represented by the call initiation details without using the mobile device as a telephone for the call.

In another embodiment of the tools and techniques, act initiation details can be automatically selected based on time information in a time-based object in a mobile device. In response to a gesture made with the mobile device and sensing a physical proximity of the mobile device to a receiving device, the selected act initiation details can be transmitted to the receiving device.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a system for transmitting act initiation details from a mobile device to a receiving device.

FIG. 3 is a flowchart of a technique for transmitting initiation details from a mobile device.

FIG. 4 is a flowchart of another technique for transmitting initiation details from a mobile device.

FIG. 5 is a flowchart of yet another technique for transmitting initiation details from a mobile device.

### DETAILED DESCRIPTION

Embodiments described herein are directed to techniques and tools for improvements in providing act initiation details to a receiving device. Such improvements may result from the use of various techniques and tools separately or in combination.

Such techniques and tools may include a mobile device that determined to be in physical proximity to a receiving device transmitting details for initiating an act to the receiving device, which can use the details to initiate the act. For example, a user may “tap” a receiving device with a handheld mobile device. In response, the mobile device can transfer details for initiating an act to the receiving device.

In one example, the receiving device can be a communication device such as a unified communications telephone (UC phone). The UC telephone and the mobile device can each be equipped with a near field communications (NFC) tag. Either the UC phone or the mobile can be the NFC reader, while the other can be in passive mode. In one embodiment, the UC phone can be the active device. For example, the UC phone may become active in one of two events: a touch without any other trigger (meaning the UC phone checks for mobile devices with NFC tags on periodic basis), or when a button on the UC phone is selected (e.g., a dial button on the UC phone). Once activated, the UC phone can receive details such as telephone number(s) and credentials from the mobile device. For example, this may be done when a user taps the mobile device against the UC phone. The UC phone can then initiate a telephone call connection setup using the details received from the mobile device. The UC phone can verify credentials received from the mobile device, and can provide access to one or more services for the mobile device. For example, the UC phone may provide access to call-in services, to a conference room projector, to network computing resources, etc. Depending on the credentials provided, the UC phone may provide access to some services, but may deny access to others. An accounting of users involved in a call may be provided, and may include a listing of a user profile associated with the credentials provided by the mobile device.

The details transmitted from the mobile device may also include details for joining additional users to a call. For example, this may include one or more telephone numbers, email addresses, user names, network addresses, etc. The UC phone may forward such information to a call-in bridge, which can join the additional users to the call. For example, the bridge may call the users, send invitations to join an ongoing call via email or network messaging, etc.

There are multiple ways that the details to be transmitted can be selected on the mobile device. For example, a user can manually select (e.g., using a touch screen interface, voice command, etc.) a calendar item such as an appointment or a meeting invitation. As another example, a user can manually select a contact item, such as a contact item for a call-in bridge that is to be used for a call. As yet another example, a calendar entry for the current time that contains the dialing information can be automatically selected.

To end a call the user may tap the mobile device against the UC phone again, or may simply press the button on the UC phone to hang up.

Accordingly, one or more benefits may be realized from the tools and techniques described herein. For example, it may be easier for actions on shared devices to be initiated using mobile devices. This can relieve users of having to manually enter initiation details, such as call-in numbers, call-in conference identifications, pass-codes, etc.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

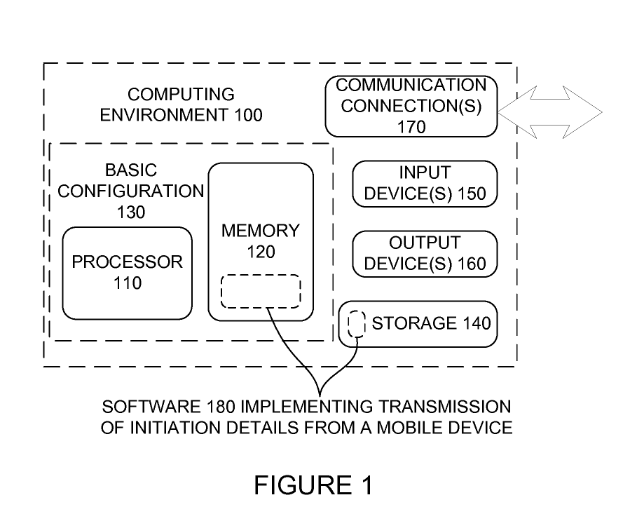

FIG. 1 illustrates a generalized example of a suitable computing environment (100) in which one or more of the described embodiments may be implemented. For example, one or more such computing environments can be used as a mobile device or a receiving device. Generally, various different general purpose or special purpose computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing transmission of initiation details from a mobile device. An implementation of the transmission of initiation details from a mobile device may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as flash drives, magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. System and Environment for Transmission of Initiation Details

A. Discussion of System Components

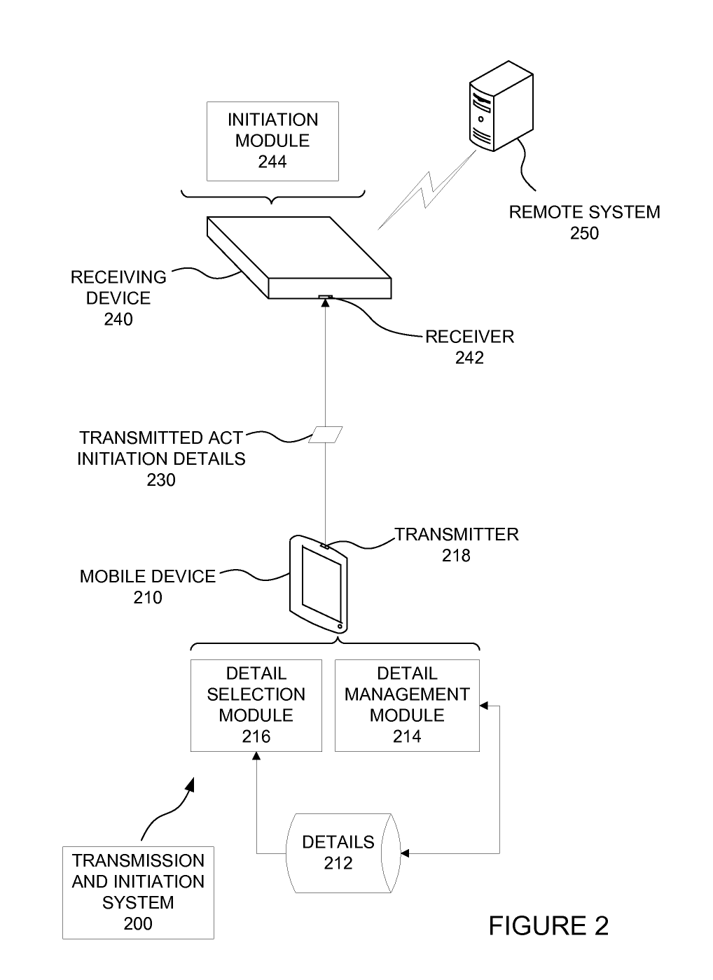

FIG. 2 is a block diagram of a transmission and initiation system (200) in conjunction with which one or more of the described embodiments may be implemented. The system (200) can include a mobile device (210), such as a smart phone, tablet computer, etc. The mobile device (210) can access stored initiation details (212). For example, these details (212) may be included in contact and calendar item objects. The mobile device (210) may also include a detail management module (214). For example, such a module (214) may be at least a portion of a contact and calendar management program, which can create and edit the initiation details (212). The mobile device (210) may also include a detail selection module (216), which can select one or more sets of details from the stored initiation details (212) to be provided to a transmitter (218). Those selected details may then be transmitted as transmitted act initiation details (230). For example, the detail selection module (216) may interact with or even be a part of a program that also includes the detail management module (214). All or part of the detail selection module (216) and the detail management module (214) may be implemented in software and/or in hardware logic. The transmitter (218) can be any of various types of transmitters for actively sending the transmitted act initiation details (230) to a receiving device (240) and/or making the transmitted act initiation details (230) available to be read by a receiver (242) in the receiving device (240).

The receiving device (240) can include an initiation module (244), which can obtain the transmitted act initiation details (230) from the mobile device (210) and initiate an act based on those details (230). For example, the initiation module (244) may be configured to make telephone calls to a remote system (250) such as a conference calling bridge system, activate a projector, print items indicated in the transmitted act initiation details (230), etc. The initiation module (244) may be implemented in hardware and/or software, such as one or more software programs, hardware logic, etc.

B. Example of Use of the System for Implementing Transmission of Initiation Details from a Mobile Device

An example of using a system such as the system of FIG. 2 for transmission of initiation details from a mobile device will now be discussed.

As has been discussed, setting up a UC phone voice or video call from a conference room can be a cumbersome process. Accordingly, transmission of initiation details in such a scenario will be discussed now as an example, with reference to FIG. 2. It should be understood that many different implementations may also be possible with the system of FIG. 2. Making a call from a UC phone may involve a user entering not just the UC phone number of the conference bridge or remote subscriber, but also possible credentials and codes that authorize the conference room to participate in the call.

In this example, the mobile device (210) of FIG. 2 can be a mobile phone carried by a user, and the receiving device (240) can be a shared UC phone in a conference room. The mobile device (210) can include stored details (212) in the form of information for contacts and calendar items. When a user wants to invoke a communication, e.g., via teleconference or directly from the receiving device (240), the user can tap the mobile device (210) against the receiving device. In response, using short range communication such as near field communications, the dialing information pertaining to the contact or scheduled calendar event (the transmitted act initiation details (230)) can be wirelessly transferred between the mobile device (210) and the receiving device (240), and the receiving device (240) can automatically establish the communication by dialing the numbers and entering the credentials in a known order. The credentials for the calling information can be aligned between the receiving device (240) and the communication end system (not shown) and entered automatically by the stationary receiving device (240) as requested by the remote party or calling/communication system (250). Credentials can include bridge numbers, passwords, pin numbers, etc.

The specific act initiation details (230) to be transmitted, e.g. number or calendar entry, can be manually selected by the user by opening a calendar or contact application on the mobile device (210). Another embodiment allows an automatic selection based on a scheduled event. For example, when a teleconference is scheduled from 2:00 PM to 3:00 PM, tapping the receiving device (240) from the mobile device (210) anytime between 2:00 PM and 3:00 PM can invoke the call. A margin of time (e.g., 5 minutes) prior to and after the scheduled call may be added.

In case of conflicts between different initiation details (e.g., between two concurrently scheduled call-in appointments) when tapping the receiving device (240), the transmission and initiation system (200) can notify a user and possibly prepare a menu with options, allowing a user to provide user input selecting one of the options. Such a menu could be provided on the receiving device (240) and/or the mobile device (210). For example, the receiving device can vibrate and display the following in a menu: “meeting topic 1” or “meeting topic 2”. A user can then provide user input to select the desired transmitted act initiation details (230).

Credentials between the receiving device (240) and the mobile device (210) can be used to authorize the user profile and differentiate the capabilities a user can use. For example, it may be that only a user profile for a user that works for a company can use the UC phones in a meeting room or make international calls. The credential verification process can involve certificates or passwords sent between the mobile device (210) and the receiving device (240), and may also involve verification by other systems and/or devices, such as the remote system (250).

The transmitter (218) and the receiver (242) can each be an NFC device. For example, the transmitter (218) can be an NFC tag, and the receiver (242) can be an NFC reader, although this could be reversed.

It should be understood that this example is only one of many examples of how the transmission and initiation system (200) could be implemented. For example, other communications techniques and/or gestures using the mobile device could be used. As one example, the mobile device (210) could be placed in a docking station to electrically connect the mobile device with the receiving device (240). In response, the transmitted act initiation details (230) could be transmitted over a wired connection (universal serial bus (USB) connection, Ethernet connection, etc.) to the receiving device (240). Also, the receiving device (240) could be any of various different types of devices, such as a printer (e.g., a printer for printing airline boarding passes), a conference room projector, etc.

### III. Techniques for Transmission of Initiation Details

Several techniques for transmission of initiation details will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique.

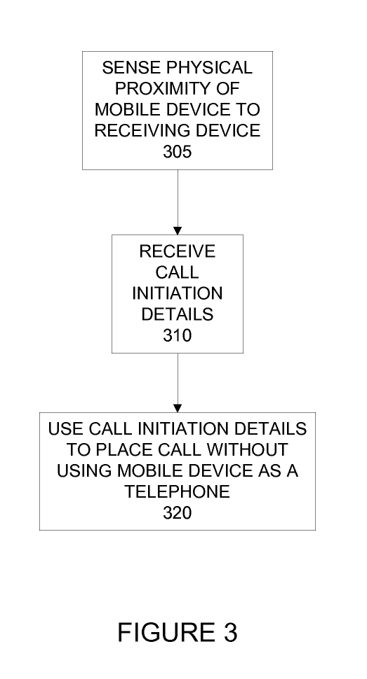

Referring to FIG. 3, a technique for transmitting initiation details from a mobile device will be described. The technique can include sensing (305) a physical proximity of a mobile device to a receiving device (e.g., a communications device such as a unified communications telephone). The technique can also include the receiving device receiving (310) call initiation details from the mobile device. The receiving device can use (320) the call initiation details to place a telephone call represented by the call initiation details without using the mobile device as a telephone for the call. Using the call initiation details to place the telephone call may be performed at least in part by hardware logic in the receiving device.

The technique of FIG. 3 can further include the mobile device automatically selecting the call initiation details. For example, this selection can include automatically selecting based on a time of an event object (such as a calendar item) on the mobile device.

Receiving (310) the call initiation details can be done in response to a gesture with the mobile device. For example, the gesture could include tapping, physical contact between the mobile device and the receiving device, and/or making electrical contact between the mobile device and the receiving device (e.g., by placing the mobile device in a docking station that has a wired connection to the receiving device). The gesture may include user input selecting from a plurality of call initiation detail choices displayed on the mobile device. The gesture may include user input selecting a contact associated with the call details.

The technique of FIG. 3 may also include terminating the call in response to a gesture with the mobile device. Additionally, the technique may include automatically deleting the call initiation details from the receiving device.

The call initiation details may include information for joining a bridge call and information for joining one or more other users into the bridge call. Such information can be forwarded by the receiving device to a conference call bridge to join the other user(s). Also, the call initiation details may include information for joining multiple additional user profiles into a call to be made by the receiving device without using a conference call bridge, in addition to joining a user profile associated with the mobile device.

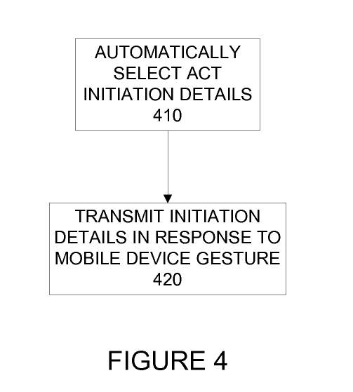

Referring now to FIG. 4, another technique for transmission of initiation details from a mobile device will be discussed. The technique can include automatically selecting (410) act initiation details based on time information in a time-based object in a mobile device. For example, this could include automatically selecting act initiation details from an event during or within a specified time of (e.g., within 5 minutes of) a time range for the event. In response to a gesture made with the mobile device and to sensing a physical proximity of the mobile device to a receiving device, the technique can include transmitting (420) the selected act initiation details to the receiving device. The gesture can include tapping with the mobile device, which can be sensed to sense the physical proximity, and transmitting (420) may be performed using near field communications.

The receiving device can include a projector, and the act initiation details can be details for initiating the projector and projecting an active object in the mobile device. For example, the active object may be an object being displayed (e.g., a word processing document currently being displayed) or an object associated with the time-based object (e.g., a representation of the object itself or a document attached to the object). The receiving device may include a printer, and the act initiation details may be details for initiating the printer and printing an active printable object in the mobile device.

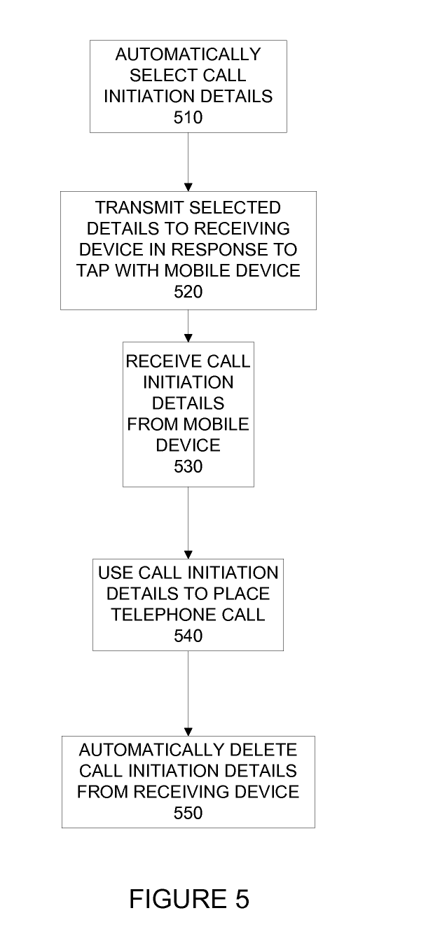

Referring to FIG. 5, yet another technique for transmission of initiation details from a mobile device will be discussed. The technique can include automatically selecting (510) call initiation details based on an event object in a scheduling program in a handheld mobile device in the computer system. The call initiation details can include details to initiate a telephone call. In response to the tap made with the mobile device and directed at the receiving device in the computer system, the technique can include transmitting (520) the selected call initiation details to the receiving device using near field communications. The receiving device can be a unified communications telephone (a UC phone). The receiving device can receive (530) the call initiation details from the mobile device in response to the tap. The receiving device can use (540) the call initiation details to place a telephone call represented by the call initiation details without using the mobile device as a telephone for the call. Additionally, the technique of FIG. 5 can include automatically deleting (550) the call initiation details from the receiving device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
sensing a proximity of a mobile device to a receiving device;
the receiving device receiving call initiation details from the mobile device; and
the receiving device using the call initiation details to place a telephone call represented by the call initiation details without using the mobile device as a telephone for the call.

2. The method of claim 1, wherein the receiving device is a unified communications telephone.

3. The method of claim 1, wherein the method further comprises the mobile device automatically selecting the call initiation details.

4. The method of claim 3, wherein automatically selecting comprises automatically selecting based on a time of an event object on the mobile device.

5. The method of claim 1, wherein receiving the call initiation details is done in response to a gesture with the mobile device.

6. The method of claim 5, wherein the gesture comprises tapping.

7. The method of claim 5, wherein the gesture comprises physical contact between the mobile device and the receiving device.

8. The method of claim 5, wherein the gesture comprises electrical contact between the mobile device and the receiving device.

9. The method of claim 5, wherein the gesture comprises user input selecting from a plurality of call initiation detail choices displayed on the mobile device.

10. The method of claim 5, wherein the gesture comprises user input selecting a contact associated with the call details.

11. The method of claim 1, wherein the method further comprises terminating the call in response to a gesture with the mobile device.

12. The method of claim 1, wherein the method further comprises automatically deleting the call initiation details from the receiving device.

13. The method of claim 1, wherein using the call initiation details to place the telephone call is performed at least in part by hardware logic in the receiving device.

14. The method of claim 1, wherein the call initiation details comprise information for joining a bridge call and information for joining one or more other user profiles into the bridge call.

15. One or more computer-readable storage media having computer-executable instructions embodied thereon that, when executed by at least one processor, cause at least one processor to perform acts comprising:
automatically selecting act initiation details based on time information in a time-based object in a mobile device; and
in response to a gesture made with the mobile device and sensing a proximity of the mobile device to a receiving device, transmitting the selected act initiation details to the receiving device.

16. The one or more computer-readable storage media of claim 15, wherein the gesture comprises tapping with the mobile device.

17. The one or more computer-readable storage media of claim 15, wherein transmitting is performed using near field communications.

18. The one or more computer-readable storage media of claim 15, wherein the receiving device comprises a projector, and wherein the act initiation details are details for initiating the projector and projecting an active object in the mobile device.

19. The one or more computer-readable storage media of claim 15, wherein the receiving device comprises a printer, and wherein the act initiation details are details for initiating the printer and printing an active printable object in the mobile device.

20. A computer system comprising:
at least one processor; and
memory comprising instructions stored thereon that when executed by at least one processor cause at least one processor to perform acts comprising:
automatically selecting call initiation details based on an event object in a scheduling program in a handheld mobile device in the computer system, the call initiation details comprising details to initiate a telephone call;
in response to a tap made with the mobile device and directed at a receiving device in the computer system, transmitting the selected call initiation details to the receiving device using near field communications, the receiving device being a unified communications telephone;
the receiving device receiving the call initiation details from the mobile device in response to the tap;
the receiving device using the call initiation details to place the telephone call represented by the call initiation details without using the mobile device as a telephone for the call; and
automatically deleting the call initiation details from the receiving device.
